(19) United States
(12) Patent Application Publication
(10) Pub. No.: US 2014/0305338 A1
(43) Pub. Date: Oct. 16, 2014

(54) AGENT FOR PAINT AND METHOD FOR MANUFACTURING THE PAINT WITH THE AGENT

(71) Applicants: Muhsin Demirci, Vantaa (FI); Jarmo Hukkanen, Kausala (FI); Ali Uzun, Helsinki (FI)

(72) Inventors: Muhsin Demirci, Vantaa (FI); Jarmo Hukkanen, Kausala (FI); Ali Uzun, Helsinki (FI)

(21) Appl. No.: 14/350,868

(22) PCT Filed: Oct. 12, 2011
(86) PCT No.: PCT/FI2011/050883

§ 371 Date: Jun. 4, 2014

(51) Int. Cl. C09D 7/12

(52) U.S. Cl. CPC C09D 7/1233; C09D 7/1216
USPC 106/215.2; 106/217.7

(57) ABSTRACT

The agent of a biological paint, such as of the paint sold under the trademark Bioboya, is a mixture comprised of water, saccharose, animal oil and/or a root plant oil, vegetable oil, wet wax, clay and silicon, into which a biological paint is combined according to the method. With an ecological indoor paint with the agent added, environmentally benign and safe properties are achieved: non-combustibility and biodegradability. Also, the paint with added agent does not produce gases and is suited, in addition to concrete surfaces, also to wood surfaces, metal surfaces, Styrox surfaces, gypsum board surfaces and plastic surfaces.

The object of the present invention is an agent for paint as defined in the preamble of claim 1 and a method for manufacturing the paint with the agent as defined in the preamble of claim 13.

The agent according to the invention is particularly well suited for biological paints, such as e.g. for the paint sold under the trademark Bioboya. By adding agent new properties for the paint, e.g. better fire protection properties, mould protection properties, insect protection properties and rodent protection properties, than before are achieved. With paint containing the agent a strongly fire-retardant property is achieved for structures that do not withstand fire.

Methods known in the art in this field of technology are silicate paints dating from 1892 and a chalk-silicate mixture in Swiss churches from the 1400s. Silicate paints are intended for concrete, and they are not suited for e.g. wood surfaces or metal surfaces.

One aim of the invention is to arrange from a water-based biological paint, such as from the paint sold under the trademark Bioboya, a paint with added agent, which is suited for use in indoor spaces on, in addition to concrete surfaces, also wood surfaces, metal surfaces, polystyrene surfaces, such as EPS insulation (brand name Styrox) surfaces, and gypsum board surfaces as well as on other plastic surfaces. The paint with added agent according to the invention added is odorless, non-combustible (fire class A1-s1-d0), non-toxic, breathing and biodegradable. A biological paint with added agent according to the invention, such as the paint sold under the trademark Bioboya, as an indoor paint containing salt brings about e.g. a salt room, which eases the condition of those suffering from asthma and atopic dermatitis. The paint with added agent does not form a film on the painted surface, in which case a breathing material is also breathing when painted. Also, the paint with added agent does not produce gases. A painted surface is dry in less than an hour, whereas with conventional ecological paints the drying time is a number of days. Paint containing the agent has, however, the basic properties of the paint in relation to color and shading. In this case e.g. the color pigments of water-based paints of other manufacturers also can be used in shading the paint when manufacturing paints of different colors.

With non-combustible paint with added agent, a fire protection wall of a building can also be produced, in which case the structure becomes lighter. In addition, with paint with added agent the production and spreading of mould is prevented, and also mould possibly already produced is removed. The paint with added agent used on a concrete-surface is also suited to outdoor use. The manufacturing costs of the paint with added agent are low. Ecological paint, such as the paint sold under the trademark Bioboya, supplemented with the agent according to the invention can be brought to function also on other than a mineral material. In this case with biological paint with added agent it is possible to replace all toxic paints with an ecological solution.

This objective is achieved according to the invention by combining the following components with biological paint, such as with the paint sold under the trademark Bioboya: at least an agent composed of water and saccharose, said agent hereinafter referred to as the “root”; at least an agent composed of animal oil and/or root plant oil, and/or vegetable oil or some other oil and/or wet wax, said agent hereinafter referred to as the “formula”; clay and silicon. With the “root” and the “formula” surface tension is removed from the paint. With the silicon moisture resistance is achieved and with the clay the drying of the paint with added agent is accelerated. With the component combination according to the invention the desired effects are achieved.

In the method according to the invention, the “root” to be manufactured from saccharose and water must be a stiff mixture. The “formula” is manufactured by mixing mixture components, such as animal oil and/or root plant oil, vegetable oil and wet wax, together. The “formula” is added to the “root”. Silicon and clay are added to the mixture of the “root” and the “formula”. If the mixture in this stage remains dry, more silicate is added to it and it is mixed well. Into this mixture the manufacturing components of a biological paint, such as of the paint sold under the trade-mark Bioboya, is added, with the silicate added last, and it is mixed. If this mixture remains dry, still more silicate is added. With the silicate, all the components can be made to mix together well. In the mixing, care should be taken not to warm the mixture. The manufacturing method according to the invention achieves a storage life of the paint with added agent of over 12 months. The desired color for the paint is achieved by adding the pigment in question before use of the paint, i.e. before the handing over of the paint from the retailer to the final user.

All the percentages presented in this application are percentages by weight.

The agent “root” according to the invention is manufactured from at least two components, e.g. by using the following type of mixing ratio:
saccharose 33-83%, preferably 67%
water 17-67%, preferably 33%

The agent “formula” according to the invention is manufactured from at least two components, preferably from components, e.g. by using the following type of mixing ratio:
animal oil and/or root plant oil 94-98%, preferably 96%
vegetable oil 1-3%, preferably 2%
wet wax 1-3%, preferably 2%

The paint with added agent according to the invention is manufactured by using e.g. the following type of mixing ratio:
“root” 4-25%, preferably 12-20%
“formula” 1-20%, preferably 6-11%
clay 1-20%, preferably 2%
silicon 0.01-2%, preferably 0.5%
and the remaining proportion the manufacturing constituents of a biological paint, such as of the paint sold under the trademark Bioboya: silicate, chalk, titanium oxide, zinc barium salt, barium sulphate and talcum.

More precisely, the paint with added agent according to the invention and the method for manufacturing it are characterized by what is presented in the characterization parts of claims 1 and 13.

Treatment with the paint with added agent according to the invention produces fire protection solutions, e.g. in missile silos. With the paint with added agent the treatment of the indoor surfaces of residential buildings produces well-being and a feeling of safety for asthmatics and for those suffering from atopic dermatitis. Timber-framed apartment blocks can be constructed by treating the frame structures of them with paint with added agent according to the invention, because the paint functions as a fire-retardant and insulating material when agent is added. This has improving effects on the diversity and aesthetics of the residential environment.

Alternative embodiments to the previous one are the addition of cereal starch and root plant starch and the mixing of them into the mixture before the addition of silicate. The proportion of cereal starch is at most 20% of the amount of the paint with added agent, preferably however 1%. By adding cereal starch the viscosity of the paint with added agent can be adjusted. The proportion of root plant starch is at most 20% of the amount of the paint with added agent, preferably however 1%. By adding root plant starch the moisture resistance of the paint with added agent can be adjusted. The proportions of the amount of agent of this embodiment correspondingly reduce the amount of silicate belonging to the biological paint, such as to the paint sold under the trademark Bioboya.

An alternative embodiment for achieving radiation prevention of the paint with added agent, more particularly when using the paint on metal surfaces, is to add and mix into the mixture minerals, e.g. graphite and/or carbon, before finally adding the silicate to be added. The proportion of minerals of the amount of the paint with added agent is preferably however 2-8%. The proportions of the amount of agent of this embodiment correspondingly reduce the amount of silicate belonging to the biological paint, such as to the paint sold under the trademark Bioboya.

It is obvious to the person skilled in the art that the invention is not limited solely to the example described above, but that it may be varied within the scope of the claims presented below.

1. Agent of a paint containing silicate, chalk, titanium oxide, zinc barium salt, barium sulphate and talcum, e.g. of a biological paint, such as of the paint sold under the trademark Bioboya, for protecting wood surface, metal surfaces, polystyrene surfaces, gypsum board surfaces and plastic surfaces, characterized in that the agent comprises at least a “root” containing saccharose and water, and also a formula containing animal oil and/or root plant oil and/or vegetable oil and/or some other oil and/or wet wax.

2. Agent according to claim 1, characterized in that the agent comprises a “root” to be manufactured from saccharose and water, a formula to be manufactured from animal oil or root plant oil, vegetable oil and wet wax; and also clay and silicon.

3. Agent according to claim 1, characterized in that of the “root”, the proportion of saccharose is 33-83% preferably 67% and the proportion of water is 17-67% preferably 33%.

4. Agent according to claim 1, characterized in that of the “formula”, the proportion of animal oil and/or root plant oil is 94-98% preferably 96%, the proportion of vegetable oil is 1-3%, preferably 2% ,and the proportion of wet wax is 1-3%, preferably 2%.

5. Agent according to claim 1, characterized in that paint with added agent contains 4-25% “root”, preferably 12-20%.

6. Agent according to claim 1, characterized in that paint with added agent contains 1-20% “formula”, preferably 6-11%.

7. Agent according to claim 1, characterized in that paint with added agent contains 1-20% clay, preferably 2%.

8. Agent according to claim 1, characterized in that paint with added agent contains 0.01-2% silicon, preferably 0.5%.

9. Agent according to claim 1, characterized in that paint with added agent can contain, in addition to “root”, “formula”, clay and silicon, also cereal starch for adjusting the viscosity of the paint with added agent and/or root plant starch for improving the moisture resistance.

10. Agent according to claim 9, characterized in that paint with added agent contains 1% cereal starch and/or 1% root plant starch.

11. Agent according to claim 1, characterized in that paint with added agent can contain, in addition to root, formula, clay and silicon, and/or cereal starch and/or root plant starch also minerals, preferably graphite and/or carbon, for improving The radiation resistance of the paint with added agent.

12. Agent according to claim 11, characterized in that paint with added agent contains 2-8% minerals.

13. Method for manufacturing paint, such as biological paint with the agent characterized in that to the mixture of saccharose and water is added a mixture of animal oil and/or root plant oil, vegetable oil and wet wax, into which mixture silicon and clay is added, into which mixture the manufacturing components of a biological paint, such as of the paint sold under the trademark Bioboya, are added, with the silicate being added last, and the mixtures are mixed well in all the adding stages.

14. Method according to claim 13, characterized in that cereal starch and/or root plant starch is added and mixed into the mixture before silicate is added.

15. Method according to claim 13, characterized in that minerals are added and mixed into the mixture before adding silicate.
